(19) United States
(12) Patent Application Publication
(10) Pub. No.: US 2025/0323924 A1
(43) Pub. Date: Oct. 16, 2025

(54) SYSTEM FOR AUTOMATICALLY DETERMINING SCAM MESSAGE INCLUDING SCAM URL

(71) Applicants: Sunyool KWON, Austin, TX (US); Yuhyun KWON, Austin, TX (US)

(72) Inventors: Sunyool KWON, Austin, TX (US); Yuhyun KWON, Austin, TX (US)

(21) Appl. No.: 18/766,585

(22) Filed: Jul. 8, 2024

(30) Foreign Application Priority Data
Apr. 12, 2024 (KR) 10-20241149300

(51) Int. Cl. H04L 9/40

(52) U.S. Cl. CPC H04L 63/1416; H04L 63/0236; H04L 63/1425

(57) ABSTRACT

The present invention provides a system for automatically determining a scam message including a scam URL, and the system includes: a user terminal for uploading, the message, an automatic determination service providing server including a confirmation unit for confirming, a check unit for checking, content of the message, an automatic determination unit for grasping whether the uploaded message matches a previously stored URL message outputting, and a guidance unit for transmitting the number of times of transmitting the message and the probability to the user terminal.

### CROSS-REFERENCE TO RELATED APPLICATIONS

This application claims priority to Korean Application No. 10-20241149300 filed on Apr. 12, 2024, the entire content of which is herein incorporated by reference in its entirety.

### TECHNICAL FIELD

The present invention relates to a system for automatically determining a scam message including a scam URL, and provides a system for determining whether or not a scam message by counting the number of times of transmitting the scam message.

### BACKGROUND OF THE INVENTION

Smishing is a compound word combining text messaging (SMS) and phishing, and is one of cyber frauds that utilize the text messaging. A smishing text message is configured of a smishing phrase and a URL through which malicious applications can be downloaded. Smishing phrases are mainly written using social engineering methods, and representative types thereof include a coupon type that hands out free coupons, a ceremonial type represented by wedding invitation, an anxiety-inducing type, a courier impersonation type, a curiosity-inducing type, and the like. The smishing process is as follows. First, a hacker transmits a text message including a URL for installing a malicious app (code) to a victim. Next, the victim clicks on the URL and downloads the malicious app. Then, the victim installs the downloaded malicious app, and the smartphone is infected. Once the smartphone is infected, the hacker can do whatever he or she desires. Typical goals of the hacker may be obtaining financial gain through theft of smartphone information or micropayment.

At this point, methods for detecting smishing by distinguishing smishing messages using deep learning or detecting whether a site is a fake site based on the volume of searching for Internet sites in the message have been researched and developed. In relation thereto, in Korean Patent Registration No. 10-2392950 (published on Apr. 29, 2022) and Korean Patent Publication No. 2022-0040186 (published on Mar. 30, 2022), which are prior arts, a configuration of collecting messages transmitted to a user terminal, inputting the messages into a text detection model, detecting intention of smishing, and providing a smishing warning to the user terminal, and a configuration of storing message information and detecting financial fraud on the basis of the volume of searching for Internet addresses in the message information are disclosed, respectively.

However, in the former case, no matter how well the smishing text is analyzed, it is not easy to distinguish whether the message is actually sent to the user or the message is a smishing message. Also in the latter case, when the volume of searching for Internet addresses is not high, the site cannot be classified as a fake site although it is a smishing message, and financial fraud cannot be detected. Scam messages, including smishing, are characterized in that although most of the scam messages include personal information, the same messages are transmitted to a plurality of users at the same time. Therefore, the user misunderstands and confuses that the message is only for him or her and clicks on the URL in many cases, and research and development of a system that can automatically determining scam messages is required taking these points into account.

### SUMMARY OF THE INVENTION

Therefore, an embodiment of the present invention may provide a system for automatically determining a scam message including a scam URL, which allows a user terminal to upload a message including a URL when the message is received, grasps whether the message matches a previously stored URL message after checking transmitter information, transmission time, and content of the message, transmits the number of times of requesting the checking, i.e., the number of times of accumulating the count, to the user terminal when the received message matches the URL message, and outputs a probability of being a scam message on the basis of the number of counts, so that the user may recognize that this is a scam message transferred to many people, not a message delivered only to the user. The system may automatically delete the scam message and block the transmitter so that the user may not click on the URL by mistake, register and manage the URL in the message as a scam site, and notify related organizations of the scam message to prevent damage in advance. However, the technical problems to be solved by the embodiment are not limited to the technical problems described above, and there may exist other technical problems.

To accomplish the above object, according to one aspect of the present invention, there is provided a system for automatically determining a scam message including a scam URL, and the system includes: a user terminal for uploading, when a message including a URL is received, the message, and outputting the number of times of transmitting the message and a probability of being a scam message; and an automatic determination service providing server including a confirmation unit for confirming, when the user terminal receives a message, whether a URL is included in the message, a check unit for checking, when the URL is included, transmitter information, transmission time, and content of the message, an automatic determination unit for grasping whether the uploaded message matches a previously stored URL message and outputting, when the uploaded message matches the previously URL message, an accumulated number of times of transmitting the message and a probability of being a scam message on the basis of the number of times of transmitting the message, and a guidance unit for transmitting the number of times of transmitting the message and the probability to the user terminal.

According to any one of the means for solving the problems of the present invention described above, it is possible to allow a user terminal to upload a message including a URL when the message is received, grasp whether the message matches a previously stored URL message after checking transmitter information, transmission time, and content of the message, transmit the number of times of requesting the checking, i.e., the number of times of accumulating the count, to the user terminal when the received message matches the URL message, output a probability of being a scam message on the basis of the number of counts so that the user may recognize that this is a scam message transferred to many people, not a message delivered only to the user, automatically delete the scam message and block the transmitter so that the user may not click on the URL by mistake, register and manage the URL in the message as a scam site, and notify related organizations of the scam message to prevent damage in advance.

### BRIEF DESCRIPTION OF DRAWINGS

FIG. 1 is a view for explaining a system for automatically determining a scam message including a scam URL according to an embodiment of the present invention.

FIG. 2 is a block diagram showing an automatic determination service providing server included in the system of FIG. 1.

FIGS. 3A-3D and FIGS. 4-6 are views for explaining an embodiment in which an automatic determination service according to an embodiment of the present invention is implemented.

FIG. 7 is an operation flowchart illustrating a method of providing an automatic determination service according to an embodiment of the present invention.

### DETAILED DESCRIPTION OF THE INVENTION

Hereinafter, embodiments of the present invention will be described in detail with reference to the attached drawings so that those skilled in the art may easily embody the present invention. However, the present invention may be implemented in many different forms and is not limited to the embodiments described herein. In order to clearly explain the present invention in the drawings, parts unrelated to the description are omitted, and similar reference numerals are given to similar parts throughout the specification.

Throughout the specification, when a part is said to be “connected” to another part, this includes the cases where it is “electrically connected” with intervention of another element therebetween, as well as the cases where it is “directly connected”. In addition, when a part is said to “include” a certain component, this means that it may further include other components, rather than excluding other components, unless specifically stated otherwise, and it should be understood that this does not preclude the presence or addition of one or more other features, numbers, steps, operations, components, parts, or combinations thereof.

The terms used throughout the specification, such as “about”, “substantially”, and the like, are used as a meaning equal or close to a number when a tolerance allowed in manufacturing or a material unique to the mentioned meaning is presented, and the terms are used to prevent unscrupulous infringers from unfairly exploiting details of the disclosure, in which precise or absolute numbers are mentioned to help understanding of the present invention. The terms used throughout the specification of the present invention, such as “step of ˜ing” or “step of˜”, do not mean “step for˜”.

In this specification, a ‘unit’ includes a unit realized by hardware, a unit realized by software, and a unit realized using both. In addition, a single unit may be realized using two or more pieces of hardware, and two or more units may be realized using one piece of hardware. Meanwhile, ‘˜ unit’ is not a meaning limited to software or hardware, and ‘˜ unit’ may be configured to be included in an addressable storage medium or may be configured to operate one or more processors. For example, ‘˜ unit’ includes components such as software components, object-oriented software components, class components, and task components, processes, functions, attributes, procedures, sub-routines, segments of program code, drivers, firmware, microcode, circuits, data, databases, data structures, tables, arrays, and variables. Functions provided within the components and ‘units’ may be combined as a smaller number of components and ‘units’ or may be further divided as additional components and ‘units’. In addition, the components and ‘units’ may be implemented to operate one or more CPUs within a device or a secure multimedia card.

In this specification, some of the operations or functions described as being performed by a terminal, an apparatus, or a device may be performed by a server connected to the terminal, apparatus, or device. In the same way, some of the operations or functions described as being performed by the server may also be performed by a terminal, an apparatus, or a device connected to the server.

In this specification, some of the operations or functions described as mapped to or matching the terminal may be interpreted as a meaning of being mapped to or matching the unique number of a terminal, which is identifying data of the terminal, or identification information of an individual.

Hereinafter, the present invention will be described in detail with reference to the accompanying drawings.

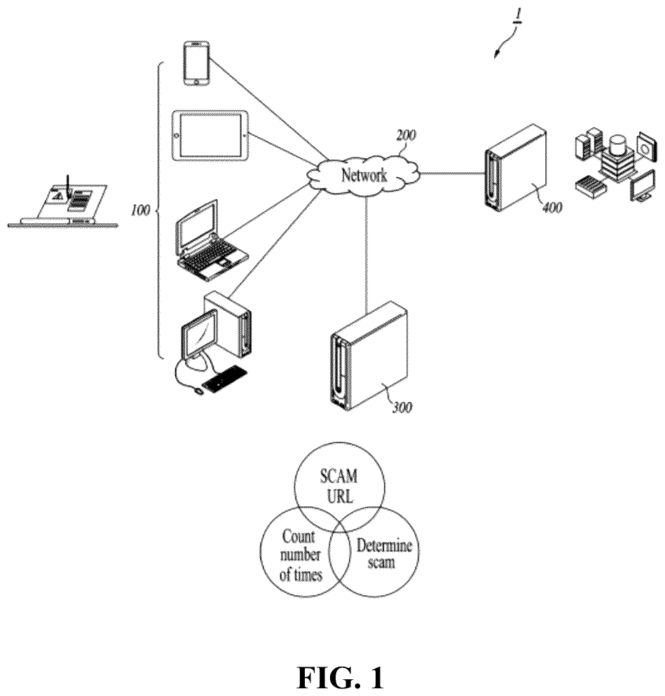

FIG. 1 is a view for explaining a system for automatically determining a scam message including a scam URL according to an embodiment of the present invention. Referring to FIG. 1, a system 1 for automatically determining a scam message including a scam URL may include at least one user terminal 100, an automatic determination service providing server 300, and at least one database 400. However, since the system 1 for automatically determining a scam message including a scam URL of FIG. 1 is only an embodiment of the present invention, the present invention is not interpreted in a limited way through FIG. 1.

At this point, each component of FIG. 1 is generally connected through a network 200. For example, as shown in FIG. 1, at least one user terminal 100 may be connected to the automatic determination service providing server 300 through the network 200. In addition, the automatic determination service providing server 300 may be connected to at least one user terminal 100 and at least one database 400 through the network 200. In addition, at least one database 400 may be connected to the automatic determination service providing server 300 through the network 200.

Here, the network means a connection structure capable of exchanging information between nodes, such as a plurality of terminals and servers, and examples of the network include local area networks (LANs), wide area networks (WANs), World Wide Web (WWW), wired and wireless data communication networks, telephone networks, wired and wireless television communication networks, and the like. Examples of the wireless data communication networks include 3G, 4G, 5G, 3rd Generation Partnership Project (3GPP), 5th Generation Partnership Project (5GPP), 5G New Radio (NR), 6th Generation of Cellular Networks (6G), Long Term Evolution (LTE), World Interoperability for Microwave Access (WIMAX), Wi-Fi, Internet, Local Area Networks (LANs), Wireless Local Area Networks (Wireless LANs), Wide Area Networks (WANs), Personal Area Networks (PANs), Radio Frequency (RF), Bluetooth networks, Near-Field Communication (NFC) networks, satellite broadcasting networks, analog broadcasting networks, Digital Multimedia Broadcasting (DMB) networks, and the like, but it is not limited thereto.

In the following description, the term ‘at least one’ is defined as a term including singular and plural, and it is apparent that although the term ‘at least one’ does not exist, each component may exist in singular or plural, and may mean singular or plural. In addition, whether each component is provided in singular or plural may be changed according to embodiments.

At least one user terminal 100 may be a terminal that uploads a message using a web page, an app page, a program, or an application related to the automatic determination service, outputs a warning about the possibility of a message for being a scam message, and blocks the originating number of the scam message and deletes the message when there is a possibility of being a scam message.

Here, at least one user terminal 100 may be implemented as a computer capable of accessing a server or a terminal at a remote site through a network. Here, the computer may include, for example, a notebook, desktop, or laptop computer equipped with a navigation system and a web browser. At this point, at least one user terminal 100 may be implemented as a terminal capable of accessing a server or a terminal at a remote site through a network. At least one user terminal 100 is, for example, a wireless communication device that guarantees portability and mobility, and may include all types of handheld-based wireless communication devices, such as a navigation system, Personal Communication System (PCS), Global System for Mobile communications (GSM), Personal Digital Cellular (PDC), Personal Handyphone System (PHS), Personal Digital Assistant (PDA), International Mobile Telecommunication-2000 (IMT-2000), Code Division Multiple Access-2000 (CDMA-2000), W-Code Division Multiple Access (W-CDMA), WiBro (Wireless Broadband Internet) terminal, smartphone, smart pad, tablet PC, and the like.

The automatic determination service providing server 300 may be a server that provides a web page, an app page, a program, or an application for automatic determination service. In addition, the automatic determination service providing server 300 may be a server that compares a message uploaded from the user terminal 100 with a previously stored URL message, updates, when the uploaded message is the same as the previously stored URL message, the number of times of checking that the messages are the same, i.e., the accumulated number of times, and transmits the updated number of times to the user terminal 100. In addition, the automatic determination service providing server 300 may be a server that registers the URL as a scam site when the number of times of checking the URL message exceeds a preset threshold value and informs related organizations to block the site. In addition, the automatic determination service providing server 300 may be a server that deletes the message from the user terminal 100 and blocks the originating number so that the user may not click on the URL by mistake.

Here, the automatic determination service providing server 300 may be implemented as a computer capable of accessing a server or a terminal at a remote site through a network. Here, the computer may include, for example, a notebook, desktop, or laptop computer equipped with a navigation system and a web browser.

At least one database 400 may be a server that stores URL messages and registers scam sites using a web page, an app page, a program, or an application related to the automatic determination service. In addition, the database 400 may be a server that loads a previously stored URL message when a comparison with a URL message is requested from the automatic determination service providing server 300, and accumulates the number of times of requesting for checking the URL message when the loaded URL message matches a comparison target.

Here, at least one database 400 may be implemented as a computer capable of accessing a server or a terminal at a remote site through a network. Here, the computer may include, for example, a notebook, desktop, or laptop computer equipped with a navigation system and a web browser. At this point, at least one database 400 may be implemented as a terminal capable of accessing a server or a terminal at a remote site through a network. At least one database 400 is, for example, a wireless communication device that guarantees portability and mobility, and may include all types of handheld-based wireless communication devices, such as a navigation system, Personal Communication System (PCS), Global System for Mobile communications (GSM), Personal Digital Cellular (PDC), Personal Handyphone System (PHS), Personal Digital Assistant (PDA), International Mobile Telecommunication-2000 (IMT-2000), Code Division Multiple Access-2000 (CDMA-2000), W-Code Division Multiple Access (W-CDMA), WiBro (Wireless Broadband Internet) terminal, smartphone, smart pad, tablet PC, and the like.

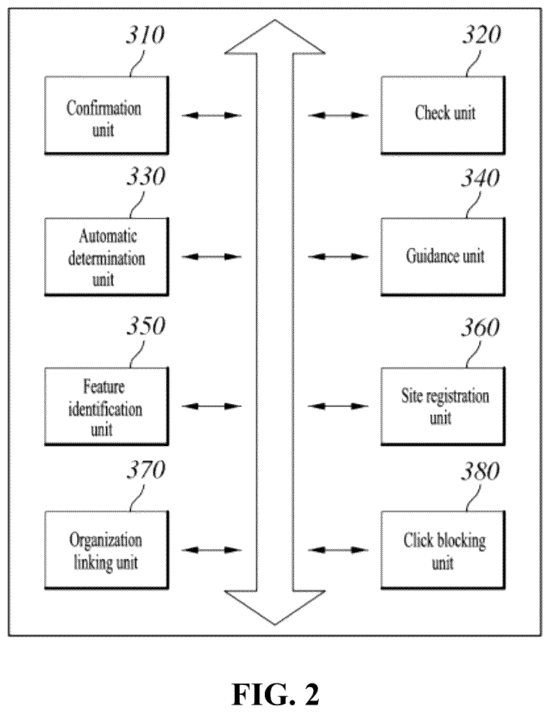

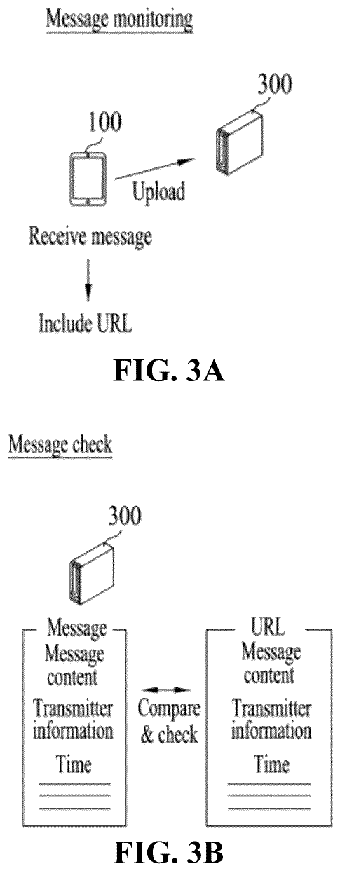

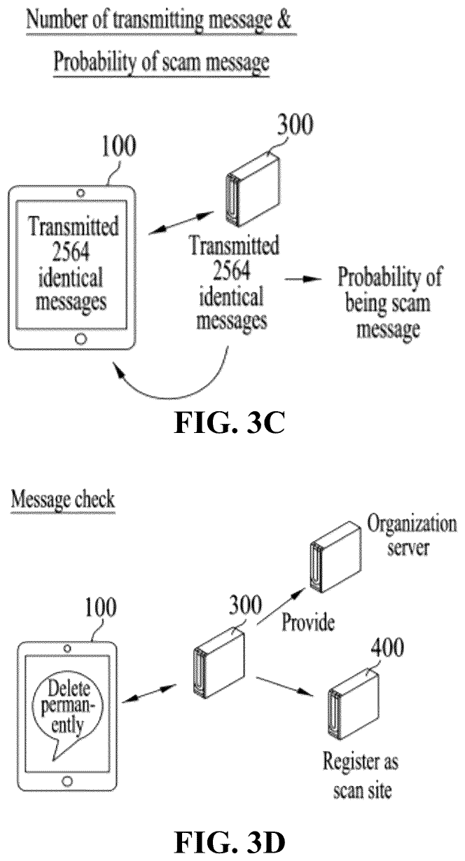

FIG. 2 is a block diagram showing an automatic determination service providing server included in the system of FIG. 1, and FIGS. 3A-3D and FIGS. 4-6 are views for explaining an embodiment in which an automatic determination service according to an embodiment of the present invention is implemented.

Referring to FIG. 2, the automatic determination service providing server 300 may include a confirmation unit 310, a check unit 320, an automatic determination unit 330, a guidance unit 340, a feature identification unit 350, a site registration unit 360, an organization linking unit 370, and a click blocking unit 380.

When the automatic determination service providing server 300 according to an embodiment of the present invention or another server (not shown) operating in association transmits an application, a program, an app page, a web page, or the like for automatic determination service to at least one user terminal 100 and at least one database 400, at least one user terminal 100 and at least one database 400 may install or open the application, program, app page, web page, or the like for automatic determination service. In addition, a service program may be driven in at least one user terminal 100 and at least one database 400 using a script executed in a web browser. Here, the web browser is a program that allows to use of the web (WWW: World Wide Web) service and means a program that receives hypertext written in the Hyper Text Mark-up Language (HTML) and displays the text. For example, the web browser includes Chrome, Microsoft Edge, Safari, FireFox, Whale, UC Browser, and the like. In addition, the application means an application program on a terminal and includes, for example, an app executed on a mobile terminal (smartphone).

Referring to FIG. 2, when the user terminal 100 receives a message, the confirmation unit 310 may confirm whether a URL is included in the message. When a message including a URL is received, the user terminal 100 may upload the message. At this point, any message including a URL may be uploaded to the confirmation unit 310. The confirmation unit 310 registers the uploaded message as a URL message, and compares the message with messages continuously uploaded by the check unit 320 and counts whether the messages are the same.

When a URL is included, the check unit 320 may check the transmitter information, transmission time, and content of the message. At this point, whether the transmitter information, i.e., phone number, is the same, the transmission time is the same, the message content is the same, or the URL is the same is checked. At this point, although the originating number or the message may be slightly different, the format may be similar. Accordingly, when the format is completely the same, the number of times of checking will be increased naturally, but the number of times of checking may also be increased even when the format is similar. Although the number of times of checking is increased by 1 when there is message A completely the same as message A, i.e., a URL message, the number of times of checking may also be increased by 1 even when there is message B, of which the format is similar to that of message A.

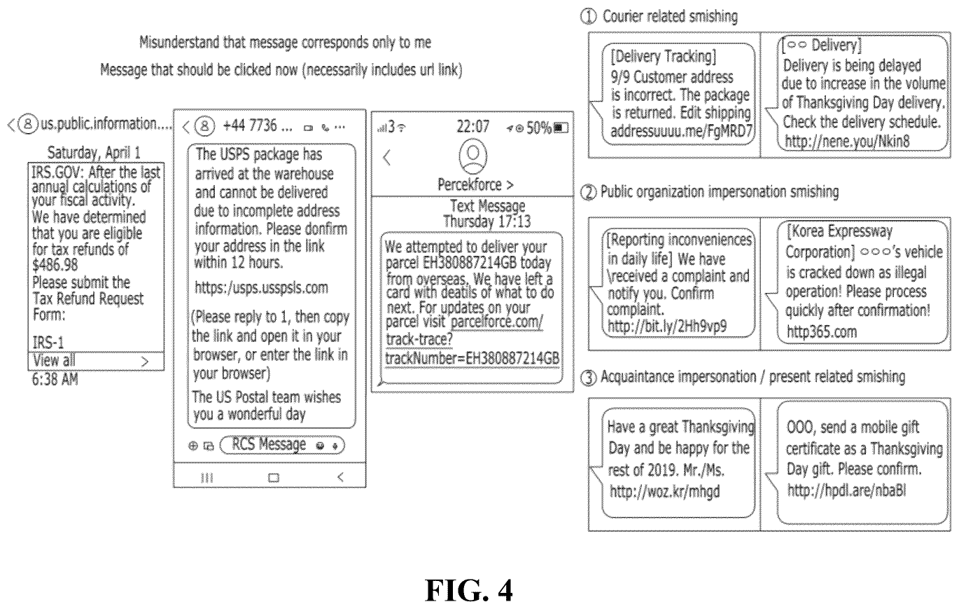

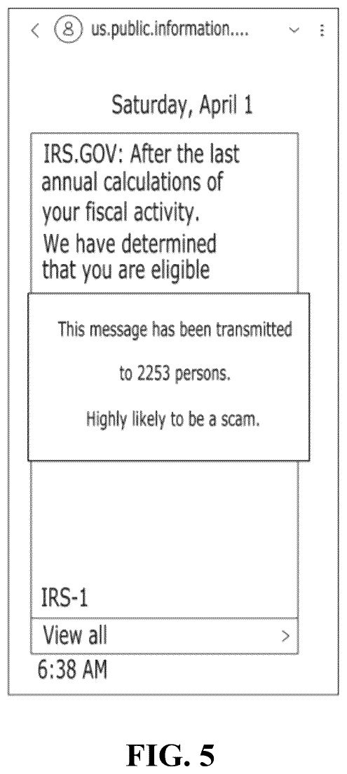

The automatic determination unit 330 may grasp whether the uploaded message matches a previously stored URL message and output, when the uploaded message matches the previously URL message, the accumulated number of times of checking and a probability of being a scam message on the basis of the number of times of checking. That is, [uploaded message-previously stored URL message] is compared. At this point, as the accumulated number of times of checking that the messages are the same or similar increases, it means that a plurality of random users has received a personal message at the same time, and this means that the probability of being a scam (fraud) message increases. For example, tracking information for delivery of product A should be transferred only to member B, but when the tracking information is transmitted to randomly selected unspecified many persons across the country, this means that the probability of being a scam message is high. As another example, information on the funeral of person B should be transferred only to acquaintances, but when the funeral information is transmitted to randomly selected unspecified many persons across the country, this also is highly probable to be a scam message. For example, a tax refund text transmitted from the National Tax Service, such as the text on the left side in FIG. 4, should be transmitted to each individual since an exact amount is written for each individual, and when the number (accumulated number) of times of checking the same text is 2253 as shown in FIG. 5, this is high probable to be a scam message. Although a message is not registered as a scam message, whether the message is a scam message may be grasped only with the number of times of counting the same message.

Of course, for the first recipient, i.e., a person who receives message A first, as the registered URL message should be his or her message (message A), it is highly possible that the user will become a victim by clicking on the URL. However, as it is controlled to output or delete the message after verifying the message by transmitting a message informing to confirm a message including a URL after verifying the message or outputting a message including a URL after a time for determining by the automatic determination unit 330 according to an embodiment of the present invention is elapsed, rather than immediately outputting the message, by the user terminal 100, the message may be processed so that even the person who receives the scam message first may not be a victim.

The guidance unit 340 may transmit the number of times of transmitting the message and the probability to the user terminal 100. The user terminal 100 may output the number of times of transmitting the message and the probability of being a scam message. At this point, the number of times of transmitting the message is the number of times of uploading a message the same as or similar to a previously stored URL message, and the probability may be proportional to this number of times.

When content corresponding to the features transmitted to an individual is included in the message content and a message including the features transmitted to the individual is transmitted to a plurality of users, the feature identification unit 350 may store the message as a URL message and count the message to increase the number of times whenever a check is requested.

As shown in FIG. 4, there are various types of messages such as courier, civil complaint, illegal crackdown target, holiday gift, health checkup result, invitation to ceremonial events, impersonation of acquaintance, and the like. However, although the types are diverse, when gathering a plurality of messages transmitted to unspecified many persons, their shapes, formats, layouts, keywords, and the like are similar. Accordingly, when a message is uploaded in real time, the features of the uploaded message can be identified and replaced when there exists a similar shape, format, layout, keyword, or the like. When it is assumed that only completely identical text is captured, a message may not be captured as the same message when only one letter or one number is different, and therefore, when these features are captured and a message has these features, it can be determined as the same message.

### <URL & Content-Based Detection Technique>

The accuracy can be compared by training the features such as the URL length that can be extracted from the URL, the number of characters in the domain, the domain length, whether or not a shortened URL, and the like using a Support Vector Machine (SVM), Decision Tree, or Random Forest algorithm. Alternatively, detection of text or contents, i.e., detection of a phishing site on the basis of contents, may be performed in addition to detection of the URL, and the presence, number, and length of each feature may be organized as a data set to conduct training and compare the accuracy using the Naive Bayes, Random Forest, SVM, Logistic Regression, K-Nearest Neighbor (K-NN), Decision Tree, Multilayer Perceptron (MLP), or XGBoost algorithm.

### <Hybrid Technique>

It is possible to use a technique of estimating using a feature of combining existence of hyperlinks, the ratio of hyperlinks moving to internal links, and the ratio of hyperlinks moving to external links, and the like into one piece of data by extracting information such as a domain name, the number of ‘.’, existence of an IP address, existence of @, the length of the URL, the number of sub-pages or sub-folders separated by ‘/’, existence of a protocol such as ‘http/https’, existence of a https protocol, existence of ‘//’ excluding protocol indication, existence of a shortened URL in the URL, and the like from the URL, and extracting the source code of the website through a crawler. This hybrid technique has a disadvantage of using both detection techniques, rather than using either URL-based or contents-based detection, when detection can be done only with the URL or URL information does not affect the detection.

At this point, a two-stage detection technique including URL-based detection and contents-based detection can be used by performing contents-based detection through a DNN model when it is a normal website after performing URL-based detection by combining Generative Adversarial Network (GAN) and Convolution Neural Network (CNN) models. When it is assumed that the ratio of phishing sites and normal sites is half and half, most normal sites will be detected using the contents-based technique, and some falsely detected phishing sites will also be detected using the contents-based technique. When there is a shortened URL in the data, there is a disadvantage of redundantly detecting a normal site and the shortened URL, information of which cannot be obtained using only the URL, on the basis of the URL and the contents.

### <Shortened URL-Preprocessing-Hybrid Technique>

In an embodiment of the present invention, all these three techniques may be used. (1) First, whether or not a shortened URL is determined (using GRU), and (2) preprocessing suitable for contents-based detection is performed when it is a shortened URL, and preprocessing suitable for URL-based detection is performed when it is not a shortened URL. In addition, (3) the third is a step of detecting a phishing site, and phishing classification is performed on the basis of XGBoost when preprocessing suitable for contents-based detection has been performed, and phishing classification is performed using a transformer when preprocessing suitable for URL-based detection has been performed.

### <Determination of Shortened URL>

The model used for determining a shortened URL is a Gated Recurrent Unit (GRU) model, which is a model that simplifies the structure of existing Long Short-Term Memory (LSTM). Through the point that the length of the shortened URL is short, speed and accuracy faster and higher than those of the LSTM can be expected by using the GRU model. The GRU model for determining a shortened URL comprises a process of [Tokenizing-Embedding-GRU]. First, it begins with tokenizing, and this is a process of generating a word set from data and dividing an arbitrary sentence into meaningful word units using the generated word set. Embedding is a process of densely vectorizing the words. Unlike the one-hot vector made up of 0s and 1s to create high-dimensional data, as the dense vector is created using low-dimensional data, where all the data are made up of real numbers, and all the data may be contracted or expanded in a specified dimension, data of a low dimension of the same size can be generated. This allows URLs configured of various characters to be digitized. Whether or not a shortened URL is determined using the data generated through the embedding process through the GRU layer.

### <URL-Based Detection>

The method used for URL-based detection is a method of performing training by extracting information from a URL and preprocessing the information into numerical data. When a process of confirming the entire URL to extract predefined information and training a machine learning algorithm is performed in detecting a phishing URL in real time, as the detection process is carried out in two stages, the data extraction process, as well as the determination process, is solved using a transformer. The transformer is a model that improves the disadvantages of Recurrent Neural Network (RNN) as it is configured of only the attention technique. The biggest characteristic of the transformer is that it receives data at once, not sequentially, and processes the data in parallel, and the transformer may make a determination by taking the entire URL string as an input without extracting URL information to train.

The transformer model does not learn information on the sequence of words that make up an input string. Therefore, information on the sequence of words should be added to the input, and this process is Positional Embedding. That is, it proceeds as a process of [Positional Embedding-Transfer Block]. After generating a positional embedding vector that describes the position of each word in the sentence using an appropriate function that generates a unique value for each position of each word, the Embedding Layer returns an embedded vector array through a process of adding the positional embedding vector to a word embedding vector. A transformer block is a set of layers configuring the transformer model. The transformer block calculates an attention through a query, a key, and a value, and outputs the calculated attention value through a feed forward network and a classification layer. The position information of the words is added to the preprocessed URL, and whether or not a phishing site is determined through the model of the transformer block.

### <Contents-Based Detection>

The contents-based detection requires a process of extracting features from a web page, and this part occupies most of the determining speed in the entire proposed technique. Therefore, in the process of determining by the model, accuracy should be secured, and the time consumed should be reduced. XGBoost is one of the algorithms that use a boosting technique, and boosting is an ensemble technique of machine learning, which is a technique for improving estimation or classification performance by combining several weak learners. A representative boosting model is the Gradient Boosting Algorithm (GBM). XGBoost is a library that implements the Gradient Boosting algorithm to enable parallel processing. Relevant features are extracted from each URL, and whether or not a phishing site is determined through the XGBoost algorithm. At this point, the features may be as shown below in Table 1, but they are not limited thereto.

TABLE 1

| # | Features of web-page contents |
|---|---|
| 1 | Number of hyperlinks present in a website |
| 2 | Internal hyperlinks ratio |
| 3 | External hyperlinks ratio |
| 4 | Number of null hyperlinks |
| 5 | External CSS |
| 6 | Internal redirection |
| 7 | External redirection |
| 8 | Generates internal errors |
| 9 | Generates external errors |
| 10 | Having login form link |
| 11 | Having external favicon |
| 12 | Submitting to email |
| 13 | Percentile of internal media |
| 14 | Percentile of external media |
| 15 | Check for empty title |
| 16 | Percentile of safe anchor |
| 17 | Percentile of internal links |
| 18 | Server Form Handler |
| 19 | iframe Redirection |
| 20 | On mouse action |
| 21 | Pop up window |
| 22 | Right_click action |
| 23 | Domain in page title |
| 24 | Domain after copyright logo |

When a previously stored URL message satisfies preset conditions, the site registration unit 360 may register the URL in the URL message as a scam site. For example, when the accumulated number of times of checking that a previously stored URL message is the same as a message uploaded from the user terminals 100 of unspecified many persons exceeds N times, the URL in this message may be stored as a scam site. When the same URL exists in the messages received by many people, this is a scam site, and it is possible to request related organizations to block accessing the site. Although website traffic, creation date, SSL certificate status, malware installations, and other indicators are analyzed recently in association with Gogolook, Criminal Investigation Bureau database, Google Web Risk service, and global database of URL risk detection service provider Scamadviser to prevent spread of fraudulent websites, when the URL messages are not registered in the database, it is difficult even to confirm whether or not a scam site. Accordingly, as shown in the method according to an embodiment of the present invention, although it is not registered as a scam site, a URL included in a message may be registered as a scam site by accumulating and counting the number of received messages, i.e., the number of messages that have been transmitted, and accordingly, even when a message is not registered, it is possible to determine whether it is a scam message and give a warning. When a message the same as a previously stored URL message is checked a preset number of times, the organization linking unit 370 may transfer the URL in the URL message to at least one related organization server (not shown). For example, when the accumulated number of times of checking that a previously stored URL message is the same as a message uploaded from the user terminals 100 of unspecified many persons exceeds N times, the URL in this message may be transferred to related organizations.

When the probability of a received message for being a scam message exceeds a preset threshold value, the click blocking unit 380 may permanently delete the message from the user terminal 100 and block the originating number of the message. Since a user may click on the URL by mistake, all messages with the URL may be disabled so that the user may not click on the URL by mistake, and when there is a possibility of being a scam message, this message may be permanently deleted, and the originating number may be blocked. Although it is not that the message will not be delivered again by blocking just one number since most smishing companies use tens to hundreds of phone numbers of similar phone number zones, when the URL message itself is disabled or deleted before the user notices, the possibility of being stolen personal information by clicking on the URL can be reduced to zero.

Hereinafter, the operation process according to the configuration of the automatic determination service providing server of FIG. 2 will be described in detail using FIGS. 3A-3D and FIGS. 4-6 as an example. However, it will be apparent that the embodiment is only one of various embodiments of the present invention and is not limited thereto.

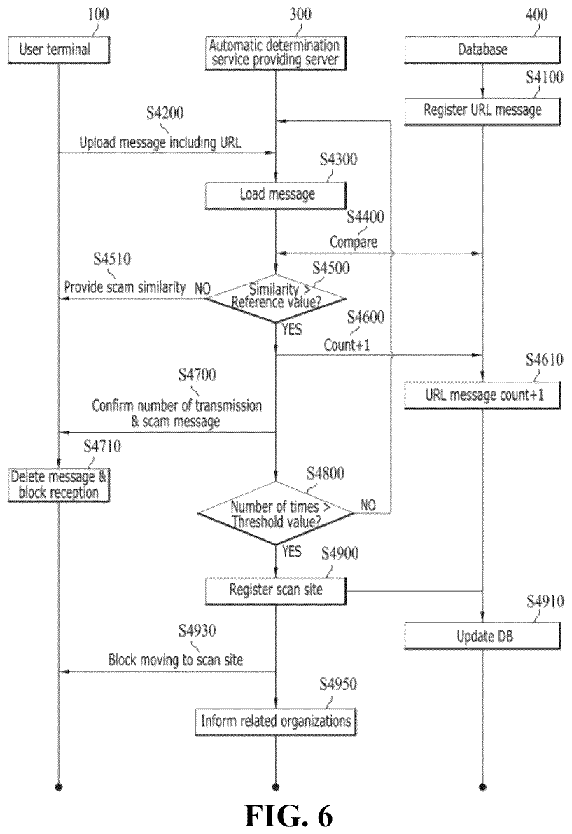

Referring to FIGS. 3A-3D, (a) When a message including a URL is uploaded from the user terminal 100, the automatic determination service providing server 300 as shown in FIG. 3A, (b) compares the uploaded message with a previously stored URL message (message including the URL) as shown in FIG. 3B, (c) increases by 1 the check indicating that the uploaded message is the same the previously stored URL message when the messages are the same or similar, counts and accumulates the number of times of checking, and transmits the accumulated number of times and the probability of being a scam message to the user terminal 100 so that the user may intuitively determine how many people have received the same message and whether this message is transmitted only for the user as shown in FIG. 3C. Then, as shown in as shown in FIG. 3D, when the number of times exceeds a preset threshold value, the automatic determination service providing server 300 may register the URL in this message as a scam site, permanently delete the message from the user terminal 100, and block the originating number. This process may be summarized as shown in FIG. 6, and the processing order is not necessarily limited thereto, and it goes without saying that the order may be changed, some steps may be added, or some steps may be omitted.

Referring to FIG. 6, when a URL message is registered in the database 400, the automatic determination service providing server 300 registers the URL message, although it is unknown yet that this is a scam message, for the purpose of checking whether a message the same as the message exists (S4100). At this point, it is assumed that there is another user terminal 100 that has uploaded the URL message for the first time. When the message is uploaded for the first time in this way and does not match an existing URL message, it is registered as a first URL message for comparison. Then, when the user terminal 100 receives a message including the URL, the user terminal 100 uploads this message to the automatic determination service providing server 300 (S4200), and the automatic determination service providing server 300 determines whether this message is the same as a previously registered URL message (S4300, S4400). When the uploaded message is not the same as a previously registered URL message, this message is registered as a first message as shown at S4100, and when the uploaded message is the same as a previously registered URL message (S4500), the automatic determination service providing server 300 increases the number that counts the same message by 1 (S4600, S4700), and informs the user terminal 100 of the possibility of being a scam message while informing how many identical messages have been transmitted (number of times) (S4700). At this point, when there is a possibility of being a scam message, the automatic determination service providing server 300 may delete this message and set to block reception of the message (S4710).

In addition, when the counted number of times exceeds a threshold value (S4800), the automatic determination service providing server 300 may register the URL as a scam site (S4900), block moving to a corresponding URL so that the user terminal 100 may not move to the URL (S4930), update the DB of the scam site in the database 400 (S4910), and inform relevant organizations that the URL is a scam site (S4950).

Since those that are not described in FIGS. 2, 3A-3D, and 4-6 with respect to the method of providing an automatic determination service are the same as those described above with respect to the method of providing an automatic determination service through FIG. 1 or may be easily inferred from the descriptions provided above, they will not be described below.

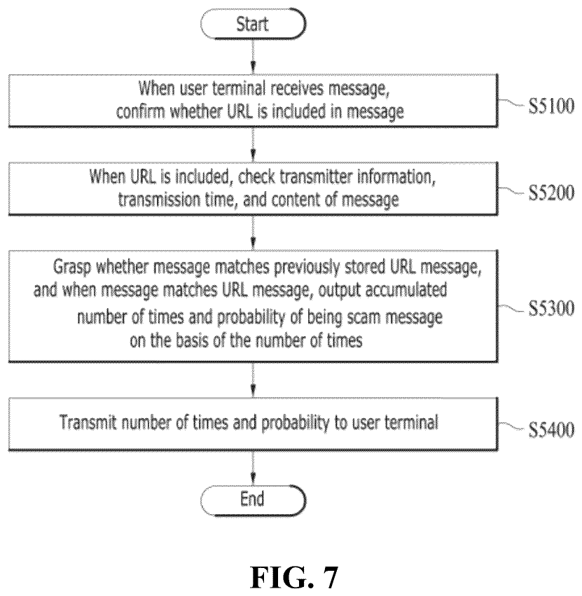

FIG. 7 is a view showing a process of transmitting and receiving data between the components included in the system for automatically determining a scam message including a scam URL of FIG. 1 according to an embodiment of the present invention. Hereinafter, although an example of transmitting and receiving data between the components will be described through FIG. 7, the present application is not interpreted as being limited to the embodiment, and it is apparent to those skilled in the art that the process of transmitting and receiving data as shown in FIG. 7 may be changed according to the various embodiments described above.

Referring to FIG. 7, the automatic determination service providing server obtains an access right for accessing the detail description of a bank account when the user terminal specifies the bank account (S5100), and when the user terminal specifies a file for storing details of deposit or remittance, the automatic determination service providing server stores the file to be linked to the bank account (S5200).

Then, the automatic determination service providing server stores the details of deposit or remittance in the designated file (S5300).

The sequence of the steps described above (S5100 to S5300) is only an example and is not limited thereto. That is, the sequence of the steps described above (S5100 to S5300) may be changed, and some of the steps may be simultaneously executed or deleted.

Since those that are not described in FIG. 7 with respect to the method of providing an automatic determination service are the same as those described above with respect to the method of providing an automatic determination service through FIGS. 1 to 6 or may be easily inferred from the descriptions provided above, they will not be described below.

The method of providing an automatic determination service according to an embodiment described with reference to FIG. 7 may also be implemented in the form of a recording medium including instructions executable by a computer, such as an application or a program module executed by a computer. Computer-readable media may be any available media that can be accessed by a computer and include both volatile and non-volatile media, and removable and non-removable media. In addition, the computer-readable media may include all computer storage media. The computer storage media include both volatile and non-volatile media, and removable and non-removable media implemented in an arbitrary method or technique for storing information such as computer-readable instructions, data structures, program modules, or other data.

The method of providing an automatic determination service according to an embodiment of the present invention described above may be executed by an application basically installed in a terminal (this may include programs included in the platform, operating system, or the like basically installed in the terminal), or may be executed by an application (i.e., a program) installed by a user himself or herself in a master terminal through an application providing server, such as an application store server, a web server related to the application or corresponding services, or the like. In this sense, the method of providing an automatic determination service according to an embodiment of the present invention described above may be implemented as an application (i.e., a program) basically installed in the terminal or installed by the user himself or herself, and stored in a computer-readable recording medium of a terminal or the like.

The description of the present invention described above is for illustrative purposes, and those skilled in the art will understand that the present invention may be easily modified into other specific forms without changing the technical spirit or essential features of the present invention. Therefore, the embodiments described above should be understood in all respects as illustrative and not restrictive. For example, each component described as a single form may be implemented in a distributed manner, and similarly, components described as distributed may also be implemented in a combined form.

The scope of the present invention is indicated by the claims described below, rather than the detailed description described above, and all changes or modified forms derived from the meaning and scope of the claims and their equivalent concepts should be construed as being included in the scope of the present invention.

What is claimed is:

1. A system for automatically determining a scam message including a scam URL, the system comprising:
a user terminal for uploading, when a message including a URL is received, the message, and outputting the number of times of transmitting the message and a probability of being a scam message; and
an automatic determination service providing server including a confirmation unit for confirming, when the user terminal receives a message, whether a URL is included in the message, a check unit for checking, when the URL is included, transmitter information, transmission time, and content of the message, an automatic determination unit for grasping whether the uploaded message matches a previously stored URL message and outputting, when the uploaded message matches the previously URL message, an accumulated number of times of transmitting the message and a probability of being a scam message on the basis of the number of times of transmitting the message, and a guidance unit for transmitting the number of times of transmitting the message and the probability to the user terminal.

2. The system according to claim 1,
wherein the automatic determination service providing server further includes a feature identification unit for storing, when content corresponding to features transmitted to an individual is included in the message content and a message including the features transmitted to the individual is transmitted to a plurality of users, the message as a URL message, and counting the message to increase the number of times whenever a check is requested.

3. The system according to claim 1,
wherein the automatic determination service providing server further includes a site registration unit for registering the URL in the URL message as a scam site when the previously stored URL message satisfies preset conditions.

4. The system according to claim 1,
wherein the automatic determination service providing server further includes an organization linking unit for transferring, when a message the same as the previously stored URL message is checked a preset number of times, the URL in the URL message to at least one related organization server.

5. The system according to claim 1,
wherein the automatic determination service providing server further includes a click blocking unit for permanently deleting, when the probability of the received message for being a scam message exceeds a preset threshold value, the message from the user terminal and blocking an originating number of the message.
